(19) United States
(12) Patent Application Publication
(10) Pub. No.: US 2015/0278361 A1
(43) Pub. Date: Oct. 1, 2015

(54) USER TERMINAL AND CONTROL METHOD THEREOF

(71) Applicant: Samsung Electronics Co., Ltd., Suwon-si (KR)

(72) Inventor: Young-min YOO, Suwon-si (KR)

(21) Appl. No.: 14/628,719

(22) Filed: Feb. 23, 2015

(30) Foreign Application Priority Data
Mar. 26, 2014 (KR) 10-2014-0035143

(51) Int. Cl. G06F 17/30; G06F 3/0482; G06F 3/0484

(52) U.S. Cl. CPC G06F 17/30864; G06F 3/04842; G06F 17/3089; G06F 3/0482

(57) ABSTRACT

A user terminal and a control method thereof are provided. The user terminal includes a display configured to display a screen, a user input unit configured to receive a user input for searching contents of a first device, and a controller configured to perform control to display, on a first screen, a plurality of contents searched in the first device based on a keyword corresponding to the user input received on the first screen, and if a content is selected from among the plurality of contents, to emphatically display information corresponding to the keyword searched for in the selected content as information received from a second device different from the first device on a second screen.

### CROSS-REFERENCE TO RELATED APPLICATION(S)

This application claims the benefit under 35 U.S.C. §119(a) of a Korean patent application filed on Mar. 26, 2014 in the Korean Intellectual Property Office and assigned Serial number 10-2014-0035143, the entire disclosure of which is hereby incorporated by reference.

### TECHNICAL FIELD

The present disclosure relates to a user terminal and a control method thereof. More particularly, the present disclosure relates to a user terminal and a control method thereof, in which information corresponding to a keyword is emphatically displayed on a new content page as well as a current page when the keyword is searched through a user terminal.

### BACKGROUND

A user inputs a keyword through a browser, a search site or the like, and searches for his/her desired information. In this case, if the information is indexed so as to emphatically display the keyword, a user can efficiently search the information by looking for the emphatically displayed keyword, such as a highlighted keyword.

When the keyword is input through a web page of the search site, an information index function is offered through only the web page provided by the server currently in use. However, when a web page provided by another server is opened, the information index function is not offered and it is therefore inconvenient to input the keyword again on a linked web page, another tab or the other related page. Accordingly, if a web page provided by a different server is a desired web page, the input of the keyword has to be repeated when this web page is opened. Thus, increasing fatigue and difficultly of concentration to a user.

Also, keywords similar and related to the input keyword may not be emphatically displayed, and thus a user may not be provided with contents of a field that he/she is interested in from much information. Accordingly, if a user searches information with regard to the related keywords one by one, it is a waste of time and lowers a searching efficiency, thereby rapidly increasing the fatigue.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user terminal and a control method thereof, in which information about a keyword is emphatically displayed on a new content page as well as a current page when the keyword is searched through a user terminal.

In accordance with an aspect of the present disclosure, a user terminal is provided. The user terminal includes a display configured to display a screen, a user input unit configured to receive a user input for searching contents of a first device, and a controller configured to perform control to display, on a first screen, a plurality of contents searched in the first device based on a keyword corresponding to the user input received on the first screen, and if a content is selected from among the plurality of contents, to emphatically display information corresponding to the keyword searched for in the selected content as information received from a second device different from the first device on a second screen.

The first device may be configured to be a first server, wherein the second device may be configured to be a second server, and wherein the first screen and the second screen respectively may include screens of web pages provided by the first server and the second server.

The first device is configured to be a first storage device of the user terminal, wherein the second device is configured to be a second storage device of the user terminal, and wherein the first screen and the second screen respectively may include screens of content pages provided by the first storage device and the second storage device.

The controller may be further configured to emphatically display the information corresponding to the keyword searched for in the selected contents on the first screen.

The controller may be further configured to determine at least one of a webpage, a document, a text, an image, and a moving image, as matched with the keyword within execution information of the selected contents.

The contents may include at least one of a web page, a document, an image, and a moving image.

The controller may be further configured to determine at least one of a text corresponding to the keyword, an image shaped like the text, a text within at least one of an image and a moving image, and an image previously set, to correspond to the text.

The controller may be further configured to determine an emphasis effect applied to at least one of the text, the image and the moving image, matched up with the keyword, within at least one of the execution information of the web page, the document, the text, the image, and the moving image of the selected contents.

The controller emphatically may display the information corresponding to the keyword in an entirety of the display or a partial area of the display.

The user terminal further may include a User Interface (UI) generator configured to generate a menu button for selectively releasing or executing the information corresponding to the emphatically displayed information corresponding to the keyword, wherein the controller may be further configured to control the UI generator to generate the menu button for releasing or executing the information corresponding to the emphatically displayed information corresponding to the keyword.

The controller may be further configured to execute at least one of a color change, underlining, highlighting, italic type, shape change, enlargement, and reduction to emphatically display the information corresponding to the keyword.

The user terminal further may include a communicator configured to communicate with an external search server, wherein the controller may be further configured to transmit the user input to an external search server so that related keywords corresponding to the keyword can be searched according to a search method, and to emphatically display information corresponding to at least one of the keyword and the related keywords if the related keywords are received from the external search server.

The controller may be further configured to execute a search method configuring a search classification about at least one of a matter of interest on a network, a trend, a tendency, a fashion, an issue, and interesting fields previously set up by the user, and wherein the controller may be further configured to execute a search for the related keyword according to at least one of a high frequency and a high priority with regard to at least one of a simultaneous search and a related search when the keyword is searched with respect to the configured search classification.

The search method may be at least one of a preset search method and a user selected search method.

In accordance with another aspect of the present disclosure, a method of controlling a user terminal is provided. The method includes displaying a searchable content, receiving a user input for searching contents of a first device, displaying, on a first screen, a plurality of contents searched in the first device based on a keyword corresponding to the user input received on the first screen, selecting a content from among the plurality of contents, and emphatically displaying information corresponding to the keyword searched for in the selected content as information received from a second device different from the first device on a second screen.

The method further may include: operating the first device as a first server; and operating the second device as a second server, wherein the first screen and the second screen respectively may include screens of web pages provided by the first server and the second server.

The method further may include operating the first device as a first storage device of the user terminal, and operating the second device as a second storage device of the user terminal, wherein the first screen and the second screen respectively may include screens of content pages provided by the first storage device and the second storage device.

The emphatically displaying of the information corresponding to the keyword on the second screen may include emphatically displaying the information corresponding to the keyword searched for in the selected contents on the first screen.

The emphatically displaying of the information corresponding to the keyword on the second screen may include determine at least one of a webpage, a document, a text, an image, and a moving image, as matched with the keyword within execution information of the selected contents, when the at least one content is displayed.

The contents may include at least one of a web page, a document, an image, and a moving image.

The emphatically displaying of the information corresponding to the keyword on the second screen may include determining at least one of a text corresponding to the keyword, an image shaped like the text, a text within at least one of an image and a moving image, and an image previously set, to correspond to the text.

The emphatically displaying of the information corresponding to the keyword on the second screen may include determining an emphasis effect applied to at least one of the text, the image, and the moving image, matched up with the keyword, within at least one of the execution information of the web page, the document, the text, the image, and the moving image of the selected contents.

The emphatically displaying of the information corresponding to the keyword on the second screen may include emphatically displaying the information corresponding to the keyword in an entirety of the display or a partial area of the display.

The emphatically displaying of the information corresponding to the keyword on the second screen may include generating a menu button for selectively releasing or executing the emphatically displayed information corresponding to the keyword.

The emphatically displaying of the information corresponding to the keyword on the second screen may include executing at least one of a color change, underlining, highlighting, italic type, shape change, enlargement and reduction to emphatically display the information corresponding to the keyword.

The emphatically displaying of the information corresponding to the keyword on the second screen may include: transmitting the user input to an external search server so that related keywords corresponding to the keyword can be searched according to a search method; receiving the related keywords from the external search server; and emphatically displaying information corresponding to at least one of the keyword and the related keywords.

The search method may include configuring a search classification about at least one of a matter of interest on a network, a trend, a tendency, a fashion, an issue, and interesting fields previously set the user, and wherein the search method further may include searching for the related keywords according to at least one of a high frequency and a high priority with regard to at least one of a simultaneous search and a related search when the keyword is searched with respect to the configured search classification.

The search method may be at least one of a preset search method and a user selected search method.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a user terminal according to an embodiment of the present disclosure;

FIG. 2 is a block diagram of a user terminal according to an embodiment of the present disclosure;

FIG. 3 is a control flowchart showing operations of a user terminal according to an embodiment of the present disclosure;

FIG. 4 is a control flowchart showing operations of a user terminal according to an embodiment of the present disclosure;

FIG. 5 shows an example of a first screen of a user terminal according to an embodiment of the present disclosure;

FIG. 6 shows an example of a second screen of a user terminal according to an embodiment of the present disclosure;

FIG. 7 shows an example of executing a document file on a first screen or a second screen of a user terminal according to an embodiment of the present disclosure;

FIG. 8 shows an example of releasing an emphasis effect through a menu button of a user terminal according to an embodiment of the present disclosure;

FIG. 9 shows an example of executing an emphasis effect through a menu button of a user terminal according to an embodiment of the present disclosure;

FIGS. 10 and 11 show examples of searching and determining a related keyword in a user terminal according to an embodiment of the present disclosure; and

FIG. 12 shows an example of showing a plurality of contents in a user terminal according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

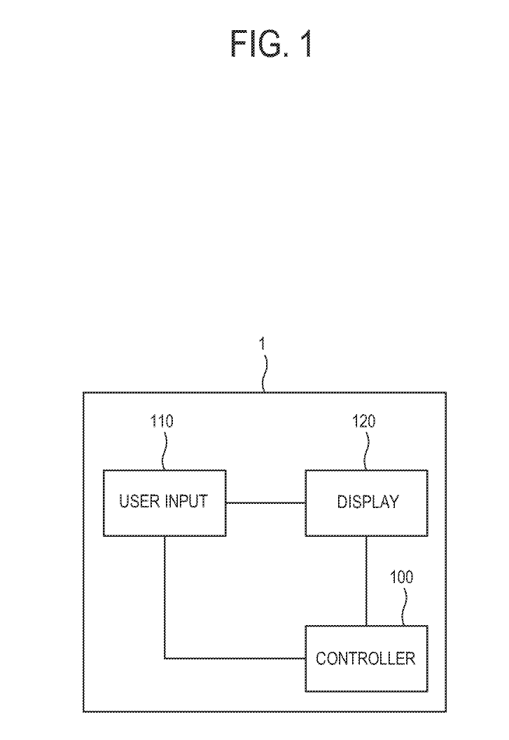

FIG. 1 is a block diagram of a user terminal according to an embodiment of the present disclosure.

Referring to FIG. 1, a user terminal 1 may include a user input 110, which may be referred to as a user input unit, device, element, item, hardware element, software element, and/or any combination thereof, a display 120, and a controller 100. The user input 110 may send the controller 100 various control commands and/or information previously set up in accordance with a user's control and inputs. The user input 110 may be achieved by a menu key or input panel installed at an outside of the user terminal 1, a remote controller separated and remote from the user terminal 1, or the like. Alternatively, the user input 110 may be integrated into the display 120. If the display 120 is a touch screen, a preset command may be issued to the controller 100 when a user touches an input menu (not shown) displayed on the display 120.

The user input 110 may receive a user's motion and sound. The user's motion may include a touch input. The user input 110 may directly receive the user's motion and sound, and/or may receive information about a user's motion and sound from an external device. The user input 110 may receive, from a user, a user's input corresponding to a keyword for searching contents.

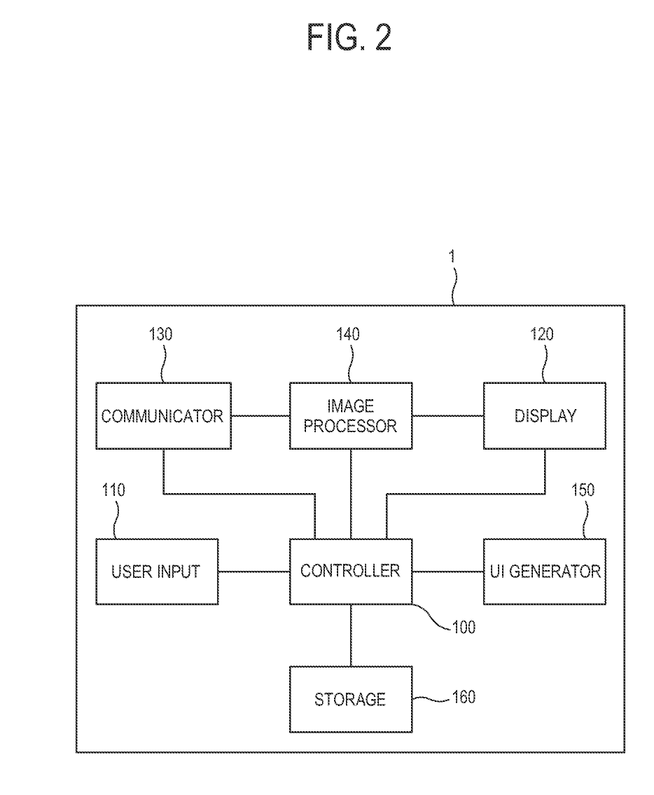

The display 120 may display an image based on an image signal output from an image processor 140 (see FIG. 2). The display 120 may be achieved in various display types such as liquid crystal, plasma, light-emitting diode, organic light-emitting diode, surface-conduction electron-emitter, carbon nano-tube, nano-crystal, etc., but not limited thereto.

The display 120 may further include additional elements in accordance with its types. For example, if the display 120 is the liquid crystal type, the display 120 may include a Liquid Crystal Display (LCD) panel (not shown), a backlight unit (not shown) for emitting light to the LCD panel, and a panel driving substrate (not shown) for driving the LCD panel.

The display 120 displays an image based on the image signal processed by the image processor 140 (see FIG. 2). The display 120 may include an LCD, a Plasma Display Panel (PDP), an Organic Light Emitting Diode (OLED), or the like type, but is not limited to the type of displaying an image. In this case, the display 120 may include an LCD panel, a PDP panel, an OLED panel, etc.

The display 120 may display an image and color compensation. The display 120 may include a display panel for displaying an image thereon, and a panel driver for processing an input image signal and driving the display panel to display an image, but the embodiments of the present disclosure are not limited thereto. The image signal received from an external input source through the interface may undergo imaging processes, such as decoding, deinterlacing, scaling, etc. and then be displayed on the display 120. If the controller 100 performs color compensation in accordance with a user's command, the display 120 may display a color compensation process with color patches and color compensated states.

The controller 100 controls a first screen to display information about a plurality of contents, which may also be referred to as contents, searched in a first device with respect to a keyword corresponding to a user's input received in the first screen, and if one content, from among the plurality of contents, is selected, the controller 100 controls a second screen to display information corresponding to the keyword involved in the selected contents as the information received from a second device different from the first device. Here, the first screen may be a screen where a list of contents searched with regard to the keyword input by a user is displayed. If one content is selected from the list of contents and activated, a new popup window may be generated or another screen may be generated after the first screen is disappears. In this case, the new popup window and the generated different screen may be regarded as the second screen. The controller 100 may also be referred to as a processor, a microcontroller, an integrated circuit, a computer chip, etc., and may be a hardware element of any suitable and/or similar type as a processor, a microcontroller, an integrated circuit, a computer chip, etc.

FIG. 2 is a block diagram of a user terminal according to an embodiment of the present disclosure.

Referring to FIG. 2, the user terminal 1 in this embodiment of the present disclosure may include the elements of FIG. 1, and may additionally include a communicator 130, an image processor 140, a storage 160, a User Interface (UI) generator 150.

The communicator 130 receives a signal based on an external input and transmits the signal to the image processor 140 and/or the controller 100. The communicator 130 connects with various external input cables and receives a signal from the corresponding external input through a wire and/or wirelessly receives a signal through a wireless communication standard.

The communicator 130 may include a plurality of connectors (not shown) to which cables are respectively connected. The communicator 130 may receive a signal from the connected external inputs, for example, a broadcasting signal, a video signal, a data signal, etc., according to a High Definition Multimedia Interface (HDMI), a Universal Serial Bus (USB), a component and the like standards, or may receive communication data through a communication network.

The communicator 130 may further include an element of receiving a signal/data from the external input, and also various additional elements such as a wireless communication module (not shown) for wireless communication and/or a tuner (not shown) to be tuned to a broadcasting signal, in accordance with designs of the user terminal 1. The communicator 130 may transmit information, data, and/or signals from the image processing apparatus to an external device in addition to receiving a signal from the external device. That is, the communicator 130 is not limited to an element for receiving a signal from the external device, but may be achieved by an interface for interactive communication that sends and receives signals. The communicator 130 may receive a control signal for selecting a UI from a plurality of control devices. The communicator 130 may include communication modules for publicly known short-range wireless communications such as Bluetooth, Infrared (IR), Ultra Wideband (UWB), Zigbee, etc., or may be achieved by a publicly known communication port for wired communication. The communicator 130 may be used for various purposes of transmitting/receiving a command for display control, data, etc., as well as a control signal for selecting the UI.

Embodiments of the present disclosure are not limited to the kinds of imaging process recited herein as being performed in the image processor 140. For example, the imaging process may include de-multiplexing for dividing a predetermined signal into signals corresponding to characteristics, decoding corresponding to a format of an image signal, de-interlacing for converting an interlaced type of an image signal into a progressive type, noise reduction for improving quality of an image, detail enhancement, frame refresh rate conversion, etc. Meanwhile, there may be provided a decoder (not shown) for decoding a source image corresponding to a format of an encoded source image, and a frame buffer (not shown) for storing the decoded source image in units of frame.

The image processor 140 may be achieved by a System-On-Chip (SOC) where various functions are integrated, and/or by individual elements for independently performing processes, and may be mounted to a printed circuit board as an image processing board (not shown) and embedded in the user terminal 1.

The image processor 140 performs various preset imaging processes with respect to a broadcasting signal including an image signal received from a receiver (not shown) and a source image including an image signal received from an image source (not shown). The image processor 140 outputs such a processed image signal to the user terminal 1, so that the processed source image can be displayed on the user terminal 1.

The UI generator 150 may generate a UI for operating an application program. The generated UI includes a plurality of sub UIs provided in the form of an icon, a text, etc. If a user selects a certain sub UI through the user terminal 1, an application program may operate corresponding to the selected sub UI. That is, each sub UI may be generated in units of plural functions and/or events for operating the application program being executed in the user terminal 1.

The UI generator 150 refers to a software and/or hardware function for generating and controlling a UI displayed on the display 120, and therefore the function of the UI generator 150 may be performed by the controller 100, as described later. In other words, the UI generator 150 may be not achieved by a separate chipset or a separate microprocessor. The UI generator 150 may generate a menu button for releasing or executing emphasis on information corresponding to a keyword.

The storage 160 may be achieved by a nonvolatile memory, e.g., a writable Read Only Memory (ROM), which may store data even though the user terminal 1 is powered off and which can reflect changes of a user. For example, the storage 160 may be provided by one of a flash Memory, an Erasable Programmable ROM (EPROM) and an Electrically EPROM (EEPROM). The storage 160 may store an application program for displaying, executing, and/or editing the contents. The storage 160 may store an identification code of the user terminal 1.

The controller 100 controls the first screen to display information about the plurality of contents, which may also be referred to as contents, searched in the first device with regard to the keyword corresponding to a user's input received in the first screen, and if one content is selected from among the contents, controls the second screen to emphatically display information corresponding to the keyword involved in the selected content as the information received from the second device different from the first device.

Here, the first device and the second device may respectively be a first server and a second server, and the first screen and the second screen may be screens of web pages provided by the first server and the second server, respectively. For example, if a user employs a search site for search and inputs a keyword for the search, the first device, i.e., the first server, provides a web page so that information about a plurality of searched contents can be displayed on the first screen. In this web page, the input keyword is emphasized, for example, the input keyword may be highlighted and/or demarcated. Further, a user selects one content from among the plurality of searched contents. Here, the one content is provided from the second device, i.e., the second server. In this case, the web page of the second screen is displayed based on the selected contents, in which the controller 100 performs control so that information corresponding to the keyword involved in the selected contents can be emphasized and displayed on the second screen. The controller 100 receives the web page of the first screen and the web page of the second screen from the first server and the second server, checks, identifies, and/or determines at least one of a text, an image and a moving image matching with the keyword in the received web pages, and controls the matching text, image and moving image to be emphatically displayed on the first screen and the second screen. Further, the first device and the second device may respectively be a first storage device of the user terminal and a second storage device of the second device, and the first screen and the second screen may respectively be screens of content pages provided by the first storage device and the second storage device. For example, a user executes a program for providing a search function in order to search data in the user terminal. A user inputs a keyword into the executed program. The first storage device of the user terminal allows the first screen to display a content page corresponding to the results of searching the input keyword. In this content page, the input keyword is emphasized. A user selects one result from among the displayed search results. This one result is a file related and/or corresponding to at least one of the text, the image and the moving image and the one result is provided by the second storage device. A program for the selected file is executed to open the file. It is checked, identified, and/or determined whether the text, the image and the moving image of the open file are matched up with the keyword, and the matched text, image and moving image are emphasized and displayed on the first screen and the second screen. Here, the first storage device and the second storage device may be different storage devices, or the same storage device. In the case where they are the same storage device, the content may be stored in and provided from different storage areas.

The controller 100 can emphatically display information corresponding to the keyword involved in the plurality of searched contents on the first screen. The plurality of searched contents may be a web page linked in a browser, or may be a file if they are searched within the user terminal 1. For instance, if a user inputs a keyword into the browser and searches the keyword, a list of linked web pages is displayed. At this time, the information corresponding to the keyword included in the list of linked web pages may be emphatically displayed.

The controller 100 can determine at least one of the text, the image and the moving image, matched up with the keyword, from among the pieces of information for executing the selected contents. If one link is selected in the list of linked web pages, the controller 100 can check information about a place of at least one of the text, the image and the moving image, matched up with the keyword, in the web page to be displayed. For example, if the checked place corresponds to a text, the controller 100 emphasizes, highlights, underlines, etc., the text and then displays it.

Here, the contents may include at least one of the web page, the document, the image and the moving image.

The controller 100 can determine at least one of a text corresponding to a keyword, an image shaped like a text, a text within an image and/or a moving image, and an image previously set up equally to the text. For instance, if an image is formed as a shape of a keyword, this image may also be information corresponding to the keyword. Further, an image and a moving image may involve a text, and this text may also be checked and emphatically displayed. Further, an image, which is previously set up and registered by a user as the image is the same as the keyword, may also be searched.

The controller 100 may determine an emphasis effect about at least one of the text, the image and the moving image, matched up with a keyword, among at least one pieces of information about a web page, a document, an image and a moving image of the contents to be displayed. The controller 100 can emphasize the information corresponding to the checked keyword by at least one of methods such as color change, underlining, highlighting, italic type, shape change, enlargement and reduction, or any other similar and/or suitable method of emphasizing the information, which can be previously set up by a manufacturer, or set up and/or changed by a user.

The controller 100 may emphatically display the information corresponding to the keyword in an entire or a partial area of the display 120. For instance, a user may do word processing while using the searched information on a certain area of the display 120. In this case, in the other area of the display 120, where the word processing is performed, there is no need of emphatically displaying an information index, i.e., the information about the keyword. Therefore, the information corresponding to the keyword is emphatically displayed within the entire or partial area of the display 120 so that the information corresponding to the keyword can be emphasized only in the area for the search.

The controller 100 may control the UI generator 150 for generating a menu button to release or execute the emphasis on the information corresponding to the keyword. Although the emphasis on the keyword is more efficient for a user to execute the search, it may be inconvenient for a user if the keyword is changed or there is no need of the emphasis on the keyword. In this regard, for the convenience of a user, a menu button is provided to release/execute the information corresponding to the emphasis on the keyword, thereby freely turning on/off the emphasis effect on the information corresponding to the keyword.

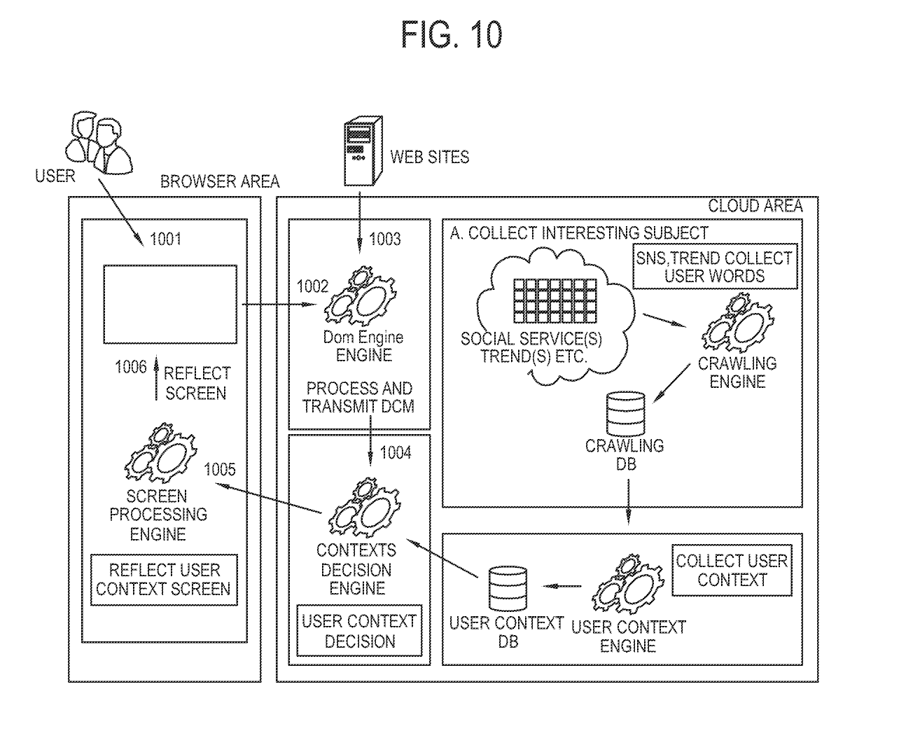

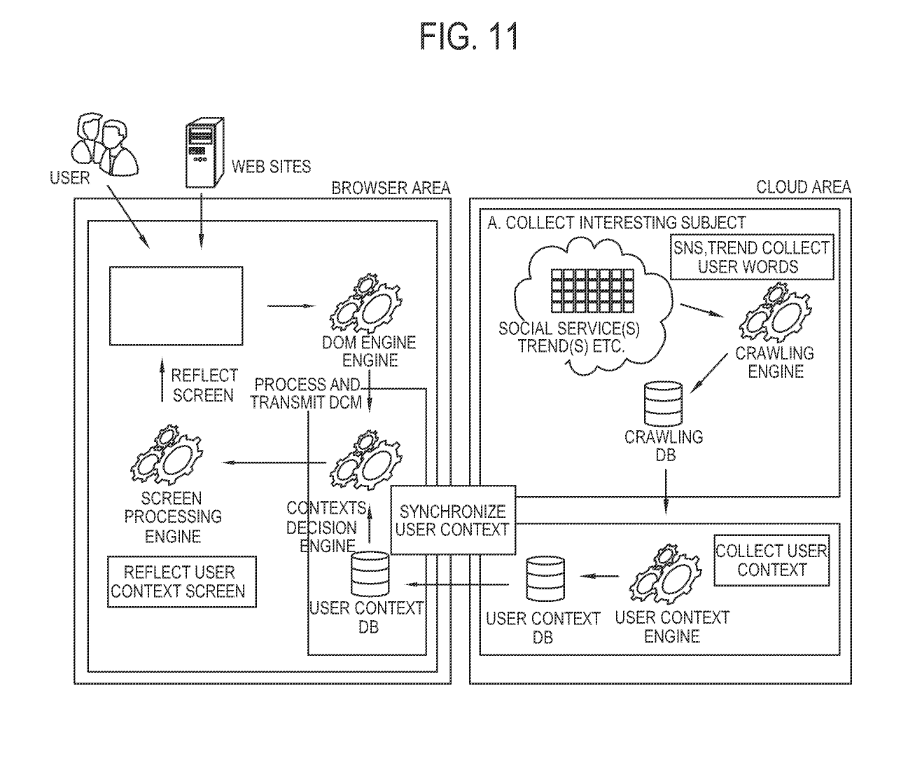

The controller 100 transmits a user's input corresponding to the received keyword to an external search server, to which the user, the user terminal 1, an electronic device, etc., may be connected to, so that relevant keywords related to the keyword can be searched by a search method, which may be a preset search method and/or a user selected search method, and controls information corresponding to at least one of the keyword and the related keywords to be emphatically displayed if the searched related keywords are received from the external search server (refer to FIGS. 10 and 11).

The controller 100 employs a method of setting up search classification about at least one of a matter of interest on a network, a trend, a tendency, a fashion, an issue, and interesting fields previously set up by a user, and employs a method of searching the related keyword according to at least one of a frequency and a priority of which is high with regard to at least one of a simultaneous search and a related search, when the keyword is searched with respect to the setup search classification, thereby allowing a user to get information about interesting fields and more extensive information. For instance, a user who is interested in a browser inputs Browser as a keyword into the user terminal. In this case, a UI, a developer, a designer, etc. are determined as the related keywords, so that at least one of a browser, a UI, a developer, a text of a designer, an image shaped like a text, the text within an image and a moving image, and an image previously set up equally to the text can be checked and emphatically displayed. Rather than one keyword, much related information corresponding to the keyword is emphatically displayed together with the keyword, thereby allowing a user to get information about his/her interesting fields and more extensive information.

The user terminal 1 can be controlled to periodically search and collect data with regard to information in which a user is interested. For example, if a keyword about the interesting field is input once, the keyword input by a user and the information corresponding to the related keyword are emphatically displayed when a web page is opened, even though a search word is not input. Also, it may be set up that the user terminal can be informed of desired contents in the collected address.

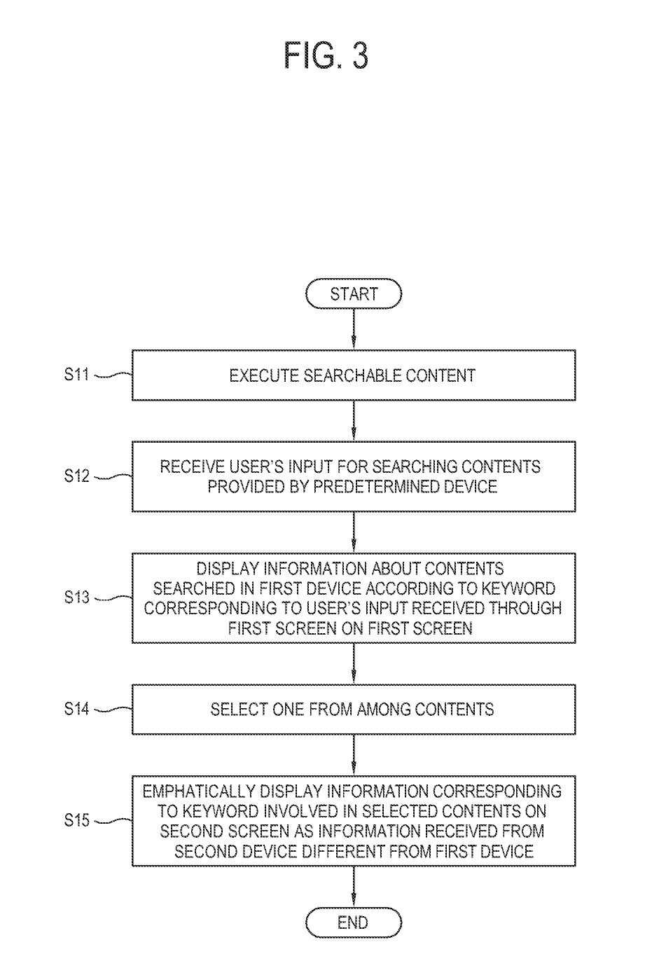

FIG. 3 is a control flowchart showing operations of a user terminal according to an embodiment of the present disclosure.

Referring to FIG. 3, searchable contents are executed at operation S11, or in other words, an operation of searching contents is executed at operation S11.

A user's input is received for searching contents provided from a predetermined device at operation S12.

The first screen displays information about the plurality of contents, which may be referred to as contents, searched in the first device with regard to and/or according to the keyword corresponding to a user's input received through the first screen at operation S13.

One content is selected from among the plurality of contents at operation S14.

The information corresponding to the keyword involved in the selected contents is emphatically displayed on the second screen as information received from the second device that is different from the first device at operation S15.

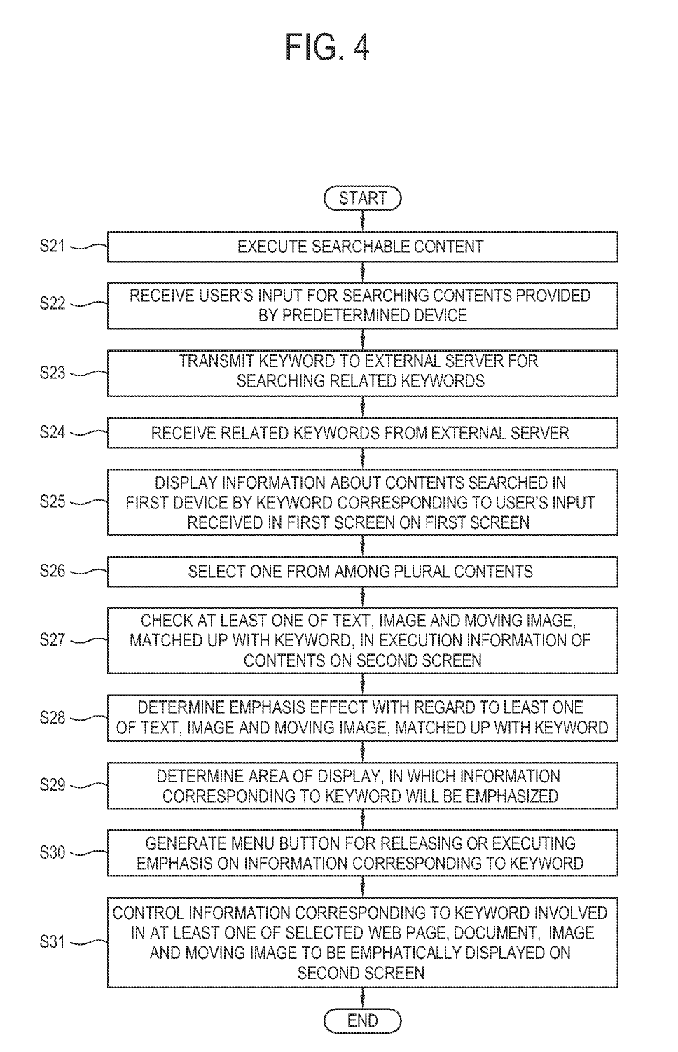

FIG. 4 is a control flowchart showing operations of a user terminal according to an embodiment of the present disclosure;

Referring to FIG. 4, searchable contents are executed at operation S21.

A user's input is received for searching contents provided from a predetermined device at operation S22.

A keyword is transmitted to an external server so as to search related keywords at operation S23. The search classification about at least one of a matter of interest on a network, a trend, a tendency, a fashion, an issue, and interesting fields previously set up by a user is periodically set up, and the related keyword, having at least one of a high frequency and a high priority with regard to at least one of a simultaneous search and a related search, is searched when the keyword is searched with respect to the setup search classification. In this regard, the search results are stored, and a change and an update are performed with the search results. Of course, the search results may be stored in the storage 160 of the user terminal 1 and on a network. Further, just a part of attribute information of the search information may be stored to reduce a storage space.

The related keywords are received from the external server at operation S24.

The first screen displays information about the plurality of contents searched in the first server by the keyword corresponding to a user's input received in the first screen at operation S25.

One content is selected among the plurality of contents at operation S26.

At least one of the text, the image and the moving image, matched up with the keyword, is checked, determined, and/or identified, in the execution information of the contents on the second screen, as the information received from the second device different from the first device at operation S27. At least one of the text, the image shaped like the text, the text within the image and moving image, and the image previously set up equally to the text, is checked, identified, and/or determined to correspond to the keyword.

The emphasis effect is determined with regard to at least one of the text, the image and the moving image, matched up with the keyword at operation S28. The information corresponding to the keyword may be emphasized by at least one of methods such as color change, underlining, highlighting, italic type, shape change, sound output, enlargement and reduction.

The controller 100 can emphasize by at least one of methods which can be previously set up by a manufacturer, and/or set up and/or changed by a user.

The area of the display, in which the information corresponding to the keyword will be emphasized is determined at operation S29.

The menu button for releasing or executing the emphasis on the information corresponding to the keyword is generated at operation S30.

The information corresponding to the keyword involved in at least one of the selected web page, document, image and moving image is controlled to be emphatically displayed on the second screen at operation S31.

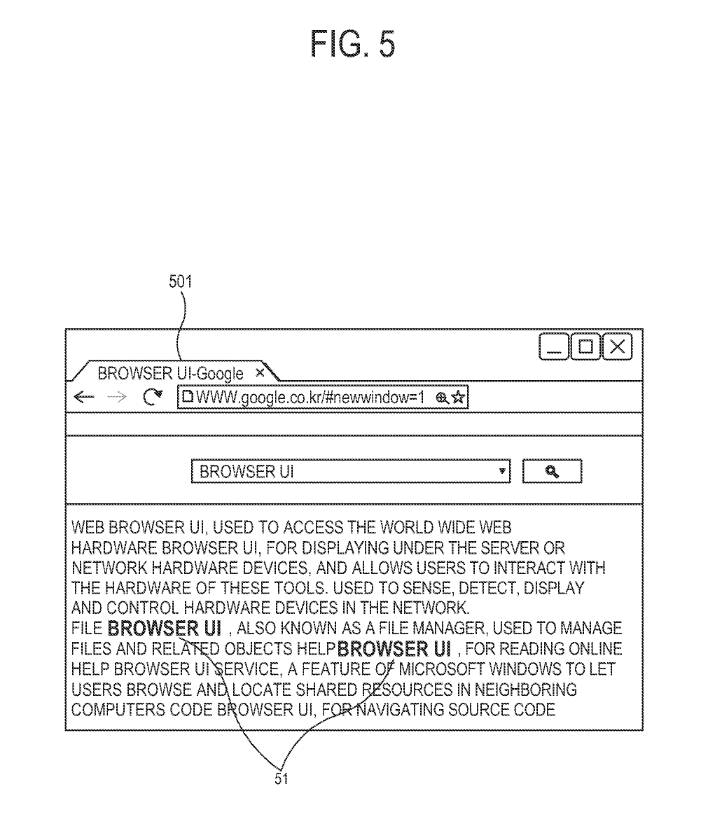

FIG. 5 shows an example of a first screen of a user terminal according to an embodiment of the present disclosure.

Referring to FIG. 5, a user inputs ‘BROWSER UI’ as a keyword for searching contents though a primary tab 501, and a plurality of contents searched in the first screen with regard to the keyword, that is, ‘BROWSER UI’ is emphatically displayed as the text of information corresponding to the keyword 51 involved in the search results. Based on the input keyword, an emphasis mark is displayed on the first screen. The example of the emphasis mark may include bold type, a font size, italic type, underlining, color change, background color, etc.

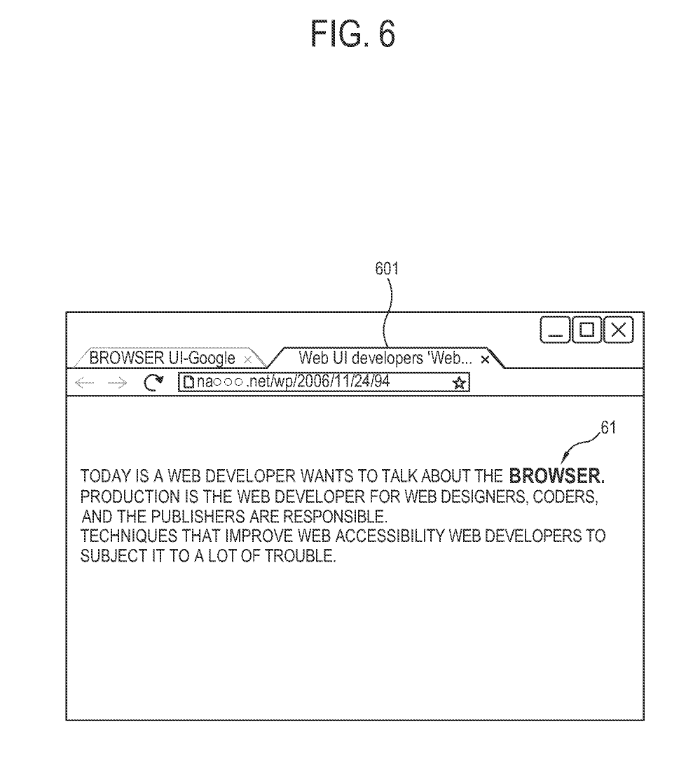

FIG. 6 shows an example of a second screen of a user terminal according to an embodiment of the present disclosure;

Referring to FIG. 6, if one of the search results is selected from the plurality of searched contents, the content selected in a secondary tab 601 may be displayed. Here, the word ‘BROWSER’ of the keyword ‘BROWSER UI’ of FIG. 5 is emphatically displayed as information corresponding to the keyword 61 involved in the selected contents.

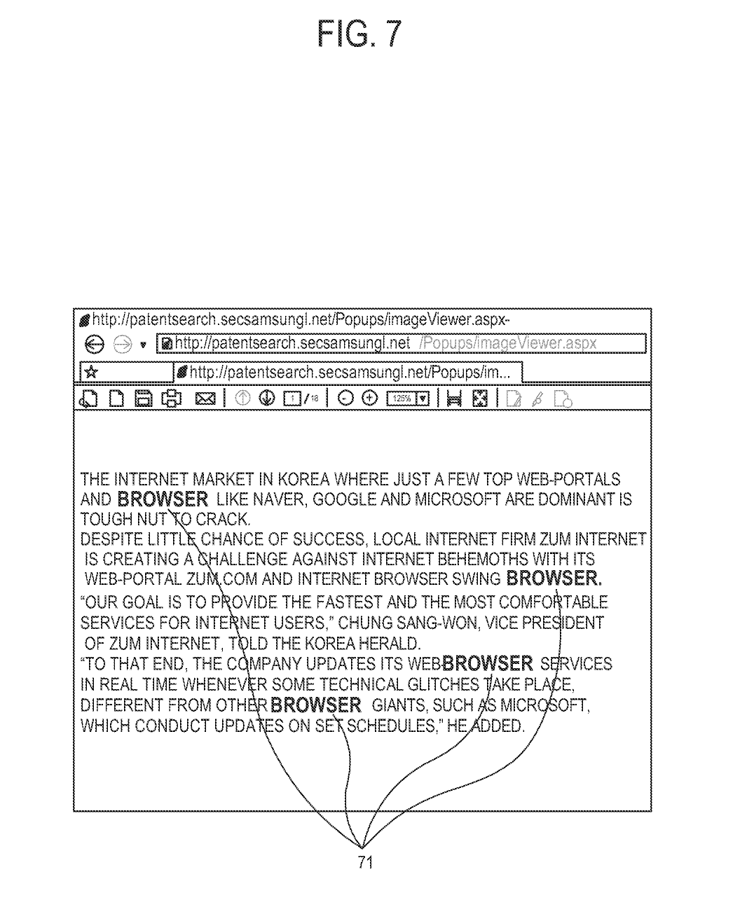

FIG. 7 shows an example of executing a document file on a first screen or a second screen of a user terminal according to an embodiment of the present disclosure.

Referring to FIG. 7, a document file is selected as one of the search results from the plurality of searched contents, and a driving program for the selected document, e.g., a document having an extension of pdf, hwp, doc, etc., is executed. The user terminal 1 searches the information corresponding to the keyword from the information about the executed selected document, and sets up the emphasis effect with regard to the positions of the information. With this process, even though the document file is opened, information corresponding to the keyword 71, i.e., the word “BROWSER” corresponding to the keyword “BROWSER UI” is emphatically displayed within the contents of the document file.

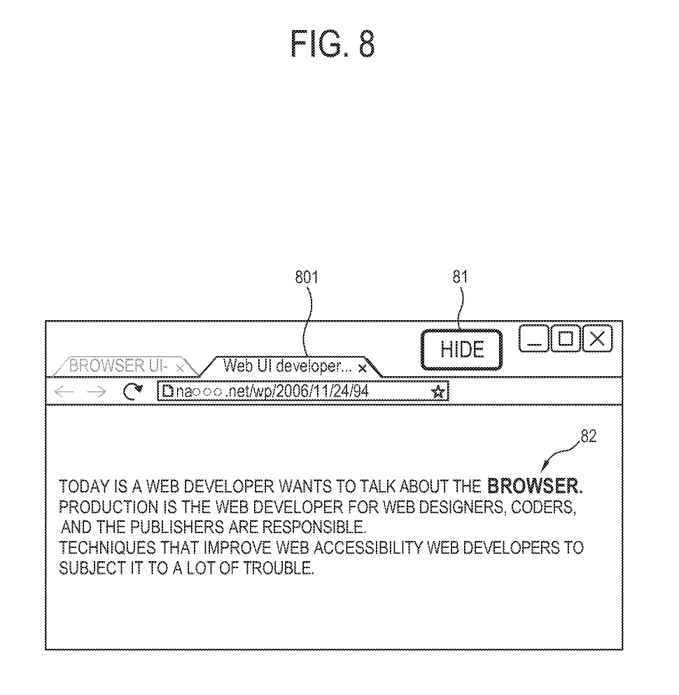

FIG. 8 shows an example of releasing an emphasis effect through a menu button of a user terminal according to an embodiment of the present disclosure.

Referring to FIG. 8, in the second screen, i.e., a secondary tab 801, a menu button 81 is provided for selectively releasing or executing the information corresponding to the emphasis on the keyword. For example, if the menu button 81 is selected once, it is set up as ‘HIDE’ and it is thus possible to hide the emphasis effect on the text of information corresponding to the keyword 82.

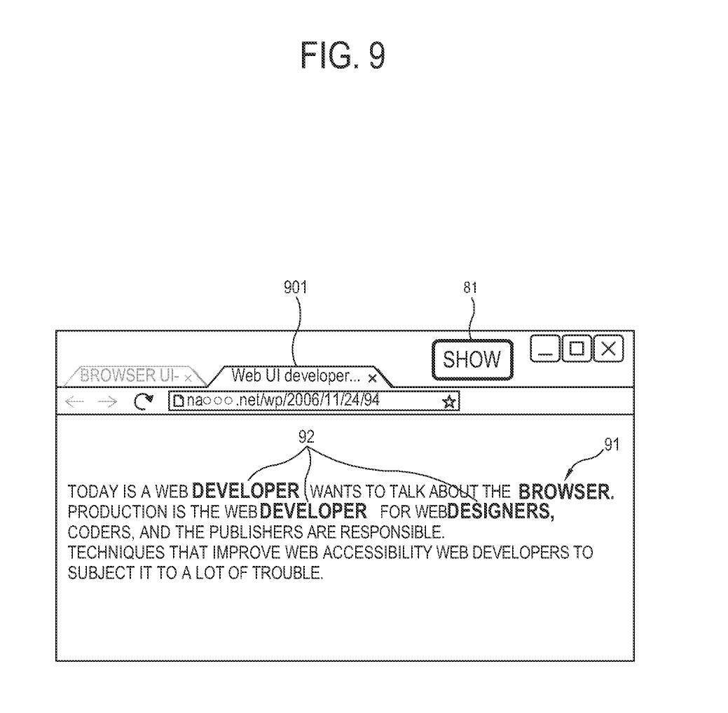

FIG. 9 shows an example of executing an emphasis effect through a menu button of a user terminal according to an embodiment of the present disclosure;

Referring to FIG. 9, in the second screen, i.e., in a secondary tab 901, the menu button 81 is provided for selectively releasing or executing the information corresponding to the emphasis on the keyword. For example, if the menu button 81 is selected once, it is set up as ‘HIDE’ and it is thus possible to hide the emphasis effect on the text of the information, as shown in FIG. 8. Furthermore, if the menu button 81 is selected twice, it is set up as ‘SHOW’, as shown in FIG. 9, and thus it is possible to have the emphasis effect on the text of the browser, i.e., the information corresponding to the keyword 91 thus emphasizing the word ‘BROWSER’. Here, the user terminal 1 may receive related keywords 92 by transmitting the keyword to the external server. Referring to FIG. 9, ‘DEVELOPER’ and ‘DESIGNER’ are emphasized and displayed as the related keywords 92.

FIGS. 10 and 11 show examples of searching and determining a related keyword in a user terminal according to an embodiment of the present disclosure.

Referring to FIG. 10, an example of a search system and a display method, in which web-site information requested from the browser of the user terminal 1 is analyzed on a cloud, and the related keywords categorized and collected corresponding to a user's keyword are determined, and then transmitted to the browser of the user terminal 1 and reflected on the screen of the user terminal 1, is shown.

Operations of receiving the related keyword includes receiving a user's keyword 1001, transmitting a network address to the cloud 1002, receiving Hypertext Markup Language (HTML) information for writing a web page from a web site 1003, processing the information in a document object engine Dom Engine 1004, transmitting the related keyword information determined by the related keyword determination engine, such as a Context Decision Engine, to the browser of the user terminal 1005, and reflecting the information about the related keyword on the first and second screens of the browser in the screen processing engine, i.e., the image processor, 1006.

Referring to FIG. 11, an example of a search system and a display method, in which results of the related keywords synchronized with the cloud on the browser of the user terminal 1 are analyzed though the related keyword determination engine, e.g., the context decision engine, and reflected on the screen of the browser of the user terminal 1, is shown.

The operations of receiving the related keywords are allocated to a client and a cloud in accordance with positions of the related keyword determination engine, i.e., the context decision engine, and positions of the related keyword information, which may operate as shown in FIG. 11 in accordance with internal/external conditions of the browser, such as network standby time or network latency, hardware, etc.

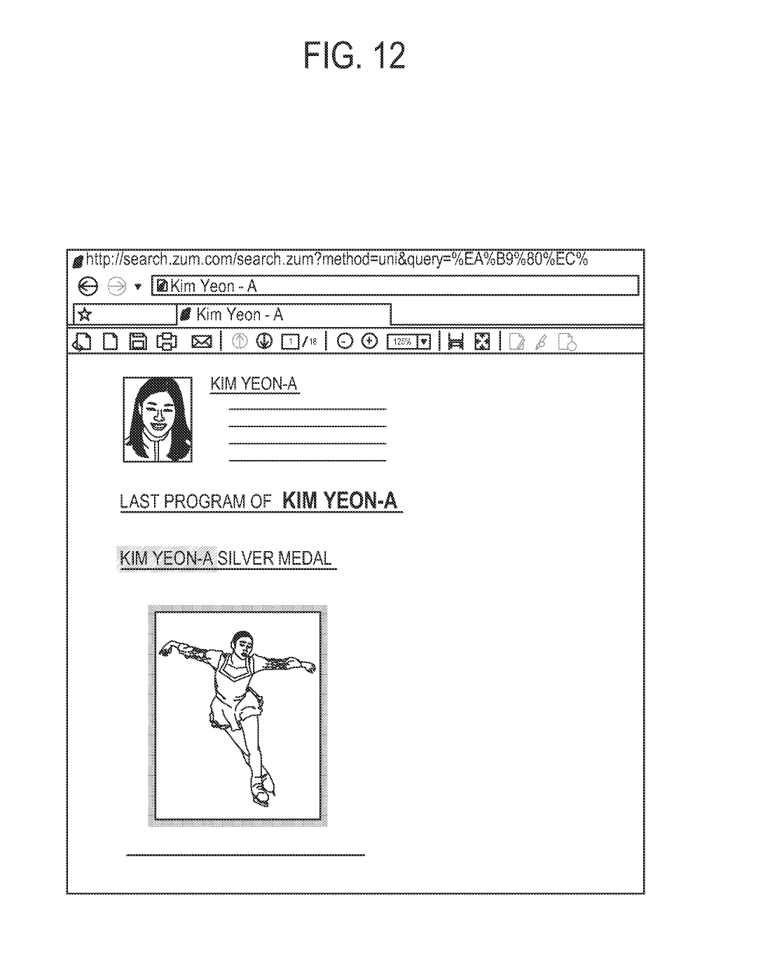

FIG. 12 shows an example of showing a plurality of contents in a user terminal according to an embodiment of the present disclosure.

Referring to FIG. 12, if a user's input is received for search, information about the plurality of contents searched in the first device or the second device by the keyword corresponding to the received user's input is displayed on the first screen or the second screen. As shown in FIG. 12, the plurality of searched contents includes the emphatically displayed text, image and moving image.

With the foregoing user terminal of the embodiments described above, the information corresponding to the keyword is continuously emphatically displayed on a new screen as well as the current screen even though the keyword is input once for the search, and thus there is no need of repetitive input of the keyword, thereby improving a user's search efficiency and lessening a user's fatigue.

According to an embodiment of the present disclosure, the information corresponding to the keyword is continuously emphatically displayed on a new screen, such as an additional screen, as well as a current screen, such as an original screen and/or a first screen, even though the keyword is input once for the search, and thus there is no need of repetitive input of the keyword, thereby having effects on improving a user's search efficiency and lessening a user's fatigue.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be appreciated by those skilled in the art that various changes in form and details may be made therein without departing from the spirit and scope of the present disclosure as defined by the appended claims and their equivalents.

What is claimed is:

1. A user terminal comprising:
a display configured to display a screen;
a user input unit configured to receive a user input for searching contents of a first device; and
a controller configured:
to perform control to display, on a first screen, a plurality of contents searched in the first device based on a keyword corresponding to the user input received on the first screen, and
if a content is selected from among the plurality of contents, to emphatically display information corresponding to the keyword searched for in the selected content as information received from a second device different from the first device on a second screen.

2. The user terminal according to claim 1, wherein the first device is configured to be a first server,
wherein the second device is configured to be a second server, and
wherein the first screen and the second screen respectively comprise screens of web pages provided by the first server and the second server.

3. The user terminal according to claim 1, wherein the first device is configured to be a first storage device of the user terminal,
wherein the second device is configured to be a second storage device of the user terminal, and
wherein the first screen and the second screen respectively comprise screens of content pages provided by the first storage device and the second storage device.

4. The user terminal according to claim 1, wherein the controller is further configured to emphatically display the information corresponding to the keyword searched for in the selected contents on the first screen.

5. The user terminal according to claim 1, wherein the controller is further configured to determine at least one of a webpage, a document, a text, an image, and a moving image, as matched with the keyword within execution information of the selected contents.

6. The user terminal according to claim 1, wherein the contents comprise at least one of a web page, a document, an image, and a moving image.

7. The user terminal according to claim 1, wherein the controller is further configured to determine at least one of a text corresponding to the keyword, an image shaped like the text, a text within at least one of an image and a moving image, and an image previously set, to correspond to the text.

8. The user terminal according to claim 5, wherein the controller is further configured to determine an emphasis effect applied to at least one of the text, the image and the moving image, matched up with the keyword, within at least one of the execution information of the web page, the document, the text, the image, and the moving image of the selected contents.

9. The user terminal according to claim 1, wherein the controller emphatically displays the information corresponding to the keyword in an entirety of the display or a partial area of the display.

10. The user terminal according to claim 1, further comprising:
a User Interface (UI) generator configured to generate a menu button for selectively releasing or executing the information corresponding to the emphatically displayed information corresponding to the keyword,
wherein the controller is further configured to control the UI generator to generate the menu button for releasing or executing the information corresponding to the emphatically displayed information corresponding to the keyword.

11. The user terminal according to claim 1, wherein the controller is further configured to execute at least one of a color change, underlining, highlighting, italic type, shape change, enlargement, and reduction to emphatically display the information corresponding to the keyword.

12. The user terminal according to claim 1, further comprising:
a communicator configured to communicate with an external search server,
wherein the controller is further configured to transmit the user input to an external search server so that related keywords corresponding to the keyword can be searched according to a search method, and to emphatically display information corresponding to at least one of the keyword and the related keywords if the related keywords are received from the external search server.

13. The user terminal according to claim 12, wherein the controller is further configured to execute a search method configuring a search classification about at least one of a matter of interest on a network, a trend, a tendency, a fashion, an issue, and interesting fields previously set up by the user, and
wherein the controller is further configured to execute a search for the related keyword according to at least one of a high frequency and a high priority with regard to at least one of a simultaneous search and a related search when the keyword is searched with respect to the configured search classification.

14. The user terminal according to claim 13, wherein the search method is at least one of a preset search method and a user selected search method.

15. A method of controlling a user terminal, the method comprising:
displaying a searchable content;
receiving a user input for searching contents of a first device;
displaying, on a first screen, a plurality of contents searched in the first device based on a keyword corresponding to the user input received on the first screen;
selecting a content from among the plurality of contents; and
emphatically displaying information corresponding to the keyword searched for in the selected content as information received from a second device different from the first device on a second screen.

16. The method according to claim 15, further comprising:
operating the first device as a first server; and
operating the second device as a second server,
wherein the first screen and the second screen respectively comprise screens of web pages provided by the first server and the second server.

17. The method according to claim 15, further comprising:
operating the first device as a first storage device of the user terminal; and
operating the second device as a second storage device of the user terminal,
wherein the first screen and the second screen respectively comprise screens of content pages provided by the first storage device and the second storage device.

18. The method according to claim 15, wherein the emphatically displaying of the information corresponding to the keyword on the second screen comprises emphatically displaying the information corresponding to the keyword searched for in the selected contents on the first screen.

19. The method according to claim 15, wherein the emphatically displaying of the information corresponding to the keyword on the second screen comprises determine at least one of a webpage, a document, a text, an image, and a moving image, as matched with the keyword within execution information of the selected contents, when the at least one content is displayed.

20. The method according to claim 15, wherein the contents comprise at least one of a web page, a document, an image, and a moving image.

21. The method according to claim 15, wherein the emphatically displaying of the information corresponding to the keyword on the second screen comprises determining at least one of a text corresponding to the keyword, an image shaped like the text, a text within at least one of an image and a moving image, and an image previously set, to correspond to the text.

22. The method according to claim 19, wherein the emphatically displaying of the information corresponding to the keyword on the second screen comprises determining an emphasis effect applied to at least one of the text, the image, and the moving image, matched up with the keyword, within at least one of the execution information of the web page, the document, the text, the image, and the moving image of the selected contents.

23. The method according to claim 15, wherein the emphatically displaying of the information corresponding to the keyword on the second screen comprises emphatically displaying the information corresponding to the keyword in an entirety of the display or a partial area of the display.

24. The method according to claim 15, wherein the emphatically displaying of the information corresponding to the keyword on the second screen comprises generating a menu button for selectively releasing or executing the emphatically displayed information corresponding to the keyword.

25. The method according to claim 15, wherein the emphatically displaying of the information corresponding to the keyword on the second screen comprises executing at least one of a color change, underlining, highlighting, italic type, shape change, enlargement and reduction to emphatically display the information corresponding to the keyword.

26. The method according to claim 15,
wherein the emphatically displaying of the information corresponding to the keyword on the second screen comprises:
transmitting the user input to an external search server so that related keywords corresponding to the keyword can be searched according to a search method;
receiving the related keywords from the external search server; and
emphatically displaying information corresponding to at least one of the keyword and the related keywords.

27. The method according to claim 26,
wherein the search method comprises configuring a search classification about at least one of a matter of interest on a network, a trend, a tendency, a fashion, an issue, and interesting fields previously set the user, and
wherein the search method further comprises searching for the related keywords according to at least one of a high frequency and a high priority with regard to at least one of a simultaneous search and a related search when the keyword is searched with respect to the configured search classification.

28. The user terminal according to claim 27, wherein the search method is at least one of a preset search method and a user selected search method.
